(19) United States
(12) Patent Application Publication
(10) Pub. No.: US 2026/0240073 A1
(43) Pub. Date: Aug. 20, 2026

(54) Engine Load Management System

(71) Applicant: Tribine Industries, LLC, Logansport, IN (US)

(72) Inventor: Ben N. Dillon, Logansport, IN (US)

(73) Assignee: Tribine Industries, LLC, Logansport, IN (US)

(21) Appl. No.: 19/532,594

(22) Filed: Feb. 6, 2026

Related U.S. Application Data
(60) Provisional application No. 63/759,273, filed on Feb. 17, 2025.

(51) Int. Cl. A01D 41/02; F02B 61/06; F02B 73/00

(52) U.S. Cl. CPC A01D 41/02; F02B 61/06; F02B 73/00

(57) ABSTRACT

Combines typically have two engines. The first engine is typically positioned on the left side on the top of the combine and is typically used for powering harvesting subsystems. The second engine is typically positioned on the right side on the top of the combine and is typically used for powering hydraulic pumps. In typical combines, the division of power provided by each engine is fixed by power transmission elements from the engine to each load element. This power is not transferable and the load ratio is fixed regardless of load requirements each engine is tasked with. The present disclosure provides an engine load management system which manages the transfer of engine load and power from the first engine to the second engine on the combine to achieve greater efficiency.

### I. BACKGROUND

The present disclosure pertains to the art of managing engine load of harvesting combines. Agricultural harvesting combines that have dual engines have certain advantages, as described in, e.g., U.S. Pat. No. 10,257,977, which is incorporated herein by reference. The load on each engine can vary based on factors such as, but not limited to, the crop being harvested, ground condition, elevation changes, crop moisture, and the amount of grain in the tank. As another example, unloading while harvesting can also produce a load change by increasing the load on the right engine. As yet another example, soybeans can require more harvesting power than corn, which requires more header and conveying power than soybeans. On such combines, the division or ratio of power provided by each engine is fixed by the power transmission elements from each engine to each load element, which are not transferable. Therefore the power required from each engine is changed by the above-discussed variables of harvesting. For example, the left harvesting engine may see a higher load in soybean harvesting. To improve the overall efficiency and thruput of the combine, this method and system are disclosed.

### II. SUMMARY

In accordance with one aspect of the present disclosure, a dual-engine agricultural harvesting combine may include means by which load is moved from one engine to the other engine.

Still other benefits and advantages of the invention will become apparent to those skilled in the art to which it pertains upon a reading and understanding of the following detailed specification.

### III. BRIEF DESCRIPTION OF THE DRAWINGS

The engine load management system may take physical form in certain parts and arrangement of parts, embodiments of which will be described in detail in this specification and illustrated in the accompanying drawings which form a part hereof and wherein:

FIG. 1 is a left side, partial cutout, view of the front part of a dual-engine agricultural harvesting combine.

FIG. 2 is a right side, partial cutout, view of the front part of the combine of FIG. 1.

FIG. 3 is a left side, partial cutout, view of the front part of a dual-engine agricultural harvesting combine according to another embodiment.

FIG. 4 is a top, partial cutout, view of a feeder house of a dual-engine agricultural harvesting combine according to another embodiment.

FIG. 5 is a right side, partial cutout, view of the front part of another embodiment of a dual-engine agricultural harvesting combine to which is attached the feeder house of FIG. 4.

### IV. DETAILED DESCRIPTION

Referring now to the drawings wherein the showings are for purposes of illustrating embodiments of the engine load management system only and not for purposes of limiting the same, and wherein like reference numerals are understood to refer to like components.

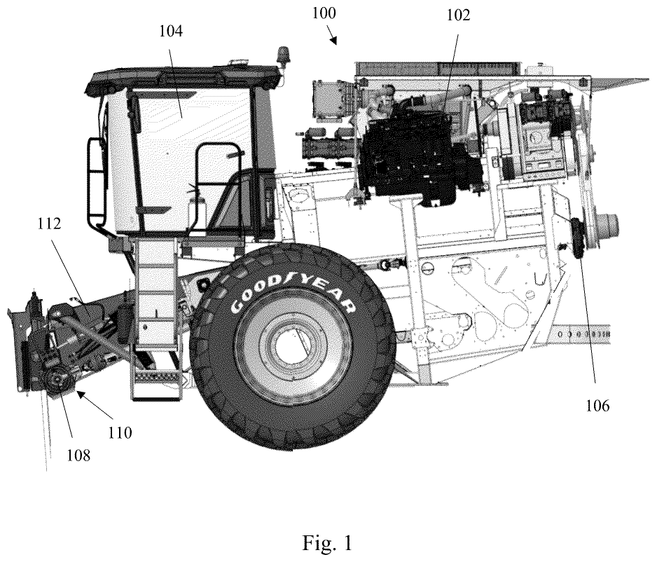

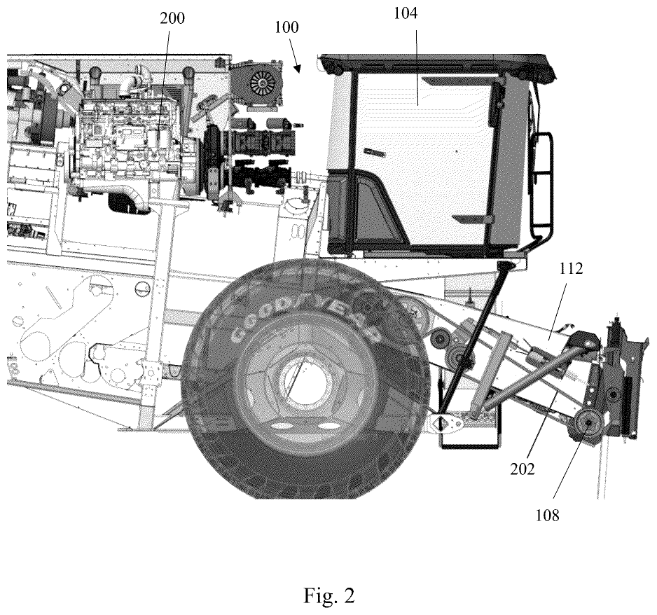

FIG. 1 shows a left side view of the front part of a dual-engine agricultural harvesting combine 100. The combine 100 is an articulated machine powered by two engines mounted longitudinally on each side of the top of the machine. An example of such a combine 100 is the Tribine Harvester (Newton, Kansas). The engines are referred to as the left engine 102 and the right engine 200 (see FIG. 2) with respect to the operator seated in the forward-mounted cab 104. The left engine 102 may power harvesting subsystems such as a threshing rotor, residue choppers, a cleaning system, a feeder house 112, a sickle cutting header, and/or a corn head.

The combine 100 may include a belt and pulley speed variator 106 (also called belt drive), which may receive power from the left engine 102. The combine may include a gearbox 110 (e.g., a “T” gearbox) at the front end which receives an input drive shaft (114) from the first engine and outputs to a lower feeder drive shaft 108. The lower feeder drive shaft 108 may receive power from the variator 106 and provide power to both a header and a feeder. Thus, the left engine 102 may drive both a header and a feeder by the variator 106. In one embodiment, power may come from the variator 106, transfer across a feeder house 112 via the lower feeder drive shaft 108 to the right side of the combine 100 (see FIG. 2), and then transfer back to power a feeder through a belt and pulley system 202 on the right side of the combine 100 as shown in FIG. 2.

FIG. 2 shows a right side view of the front part of the combine 100 and its right engine 200. The right engine 200 may power hydraulic pumps that provide oil flow at various pressures and flow rates for vehicle propulsion, steering, crop cleaning fan, engine cooling fan, grain conveying augers, and the grain tank unloading system.

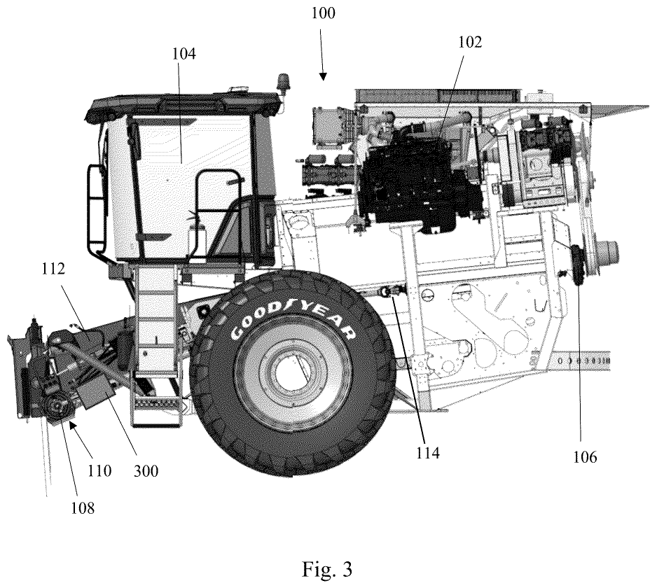

FIG. 3 shows a left side view of the front part of another embodiment of a dual-engine agricultural harvesting combine 100. The combine 100 may have essentially the same configuration as the combine 100 of FIGS. 1-2, with the addition of a clutch 300 on the input shaft of the lower feeder drive shaft 108 of the gearbox 110 on the left side of the combine 100. According to certain embodiments, the clutch 300 is an overrunning clutch. An overrunning clutch 300 is one that drives in one direction but freewheels in the other direction and thus can accommodate speed differentials. The clutch 300 allows the gearbox to free-wheel if the feeder shaft 108 is running faster than the speed the variator 106 is providing. This allows the engine load ratio to change on the go during operation. Allowing the ratio of engine loads to be changed and balanced as the above-discussed variables change (e.g., change in crop conditions) allows the overall efficiency and thruput of the combine 100 to be increased.

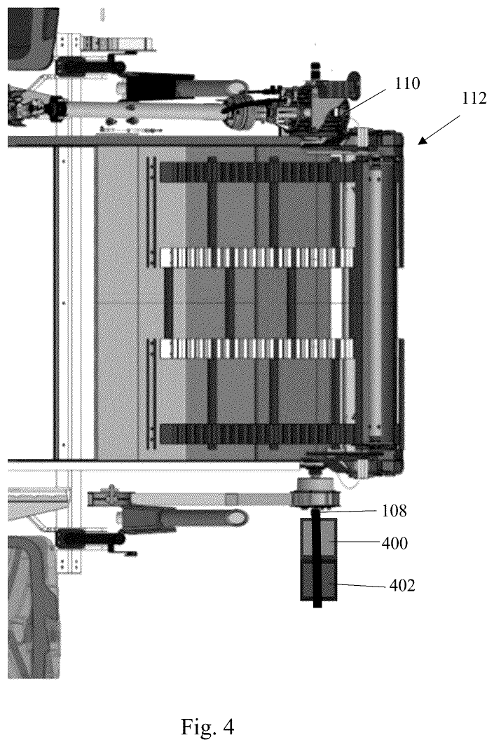

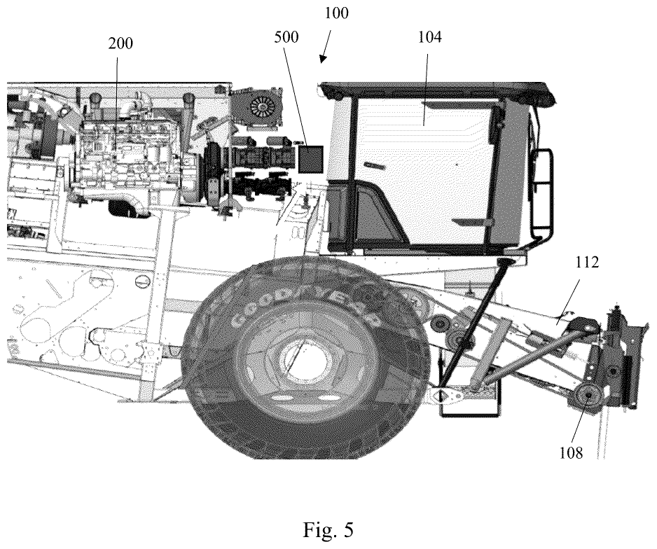

FIG. 4 shows a top view of a feeder house 112 of a combine 100 according to another embodiment. In this embodiment, the lower feeder drive shaft 108 may be extended on the right side to accommodate a second clutch 400 and a hollow shaft hydraulic motor 402. In other words, the shaft 108 in such an embodiment extends through the second clutch 400 and motor 402. According to certain embodiments, the second clutch 400 is an overrunning clutch. In alternative embodiments, the hydraulic motor 402 may be a hollow shaft gearbox/bent axis piston hydraulic motor or a hollow shaft direct drive piston motor. The hydraulic motor 402 may be powered by a hydraulic pump 500 (see FIG. 5) which is powered by the right engine 200, thereby delivering hydraulic fluid from the hydraulic pump 500 to the hydraulic motor 402 through pressure lines (not shown). An example of a hydraulic pump 500 which powers the hydraulic motor 402 is a closed loop variable displacement hydraulic pump 500 (see FIG. 5).

FIG. 5 shows a right side view of the front part of the combine 100 discussed with respect to FIG. 4. In one embodiment, the combine 100 may have essentially the same configuration as the combine 100 of FIGS. 1-2, with the addition of a hydraulic pump 500 on the right engine 200 connected to the hydraulic motor 402 which is in turn connected to the clutch 400 and lower feeder drive shaft 108. In another embodiment, the combine 100 may have the configuration discussed with respect to FIGS. 4-5 and the clutch 300 discussed with respect to FIG. 3. In yet another embodiment, the combine 100 may have essentially the same configuration as the combine 100 of FIGS. 1-2 and the clutch 300 discussed with respect to FIG. 3.

In the embodiments discussed above with respect to FIGS. 3-5, the header and feeder may be driven by whichever drive is turning faster, and the load may be transferred to the engine 102, 200 that is providing power to that drive. In alternative embodiments, the respective speeds may be set by the operator or by an automatic control system. The speeds may be set through the operation of one or more switches (manual or electrical) which may control the operation of any one or more of the clutch 300, the clutch 400, the hydraulic pump 500 and the hydraulic motor 402. In one embodiment, a variable switch may be employed (manual or electrical) allowing the hydraulic pump 500 to provide variable power to the hydraulic motor 402 depending on power needs to accommodate varying loads and to balance loads between the right engine 200 and the left engine 102. The load movement or balancing may occur while the combine 100 continues to operate and harvest. In one embodiment, the speeds may be set close together, so that if one engine 102, 200 pulls down, that engine 102, 200 may shed load to the other engine 102, 200. While the above load ratio balancing system discussed the feeder house 112 and the header drive, a number of other loads on the multi-engine combine 100 may be movable.

Additional embodiments of the engine load management system are provided below.

According to Clause 1, provided is an engine load management system for an agricultural harvesting combine having dual engines including: a first engine mounted on a first area of the agricultural harvesting combine; a second engine mounted on a second area of the agricultural harvesting combine; a belt drive which receives power from the first engine; a gearbox having an input and an output; an input drive shaft connecting the first engine to the input of the gearbox; a clutch which receives the input drive shaft and connects it to the input of the gearbox; a lower feeder drive shaft connected to the output of the gearbox, wherein the gearbox is positioned at a first end of the lower feeder drive shaft; wherein the belt drive on the first engine powers a header and a feeder; and, wherein the second engine powers hydraulic pumps.

According to Clause 2, the engine load management system of Clause 1, wherein the belt drive is a belt and pully speed variator.

According to Clause 3, the engine load management system of Clause 1 or

Clause 2, wherein the belt and pully speed variator powers a feeder house which returns power back to the feeder.

According to Clause 4, the engine load management system of any of Clauses 1 to 3, wherein the clutch connecting the input drive shaft to the gearbox is an overrunning clutch.

According to Clause 5, the engine load management system of any of Clauses 1 to 4, wherein the gearbox is a “T” gearbox.

According to Clause 6, the engine load management system of any of Clauses 1 to 5, wherein the overrunning clutch drives in one direction and freewheels in an opposite direction upon disengaging the input drive shaft from the “T” gearbox, thereby allowing for different speed differentials.

According to Clause 7, the engine load management system of any of Clauses 1 to 6, wherein the overrunning clutch allows the “T” gearbox to free-wheel if the lower feeder drive shaft is running faster than an operation speed of the belt and pully speed variator.

According to Clause 8, the engine load management system of any of Clauses 1 to 7, wherein the lower feeder drive shaft extends to engage a second clutch and a hydraulic motor, wherein the second clutch and the hydraulic motor are positioned at a second end of the lower feeder drive shaft.

According to Clause 9, the engine load management system of any of Clauses 1 to 8, wherein the second clutch is an overrunning clutch and the hydraulic motor is a hollow shaft hydraulic motor.

According to Clause 10, the engine load management system of any of Clauses 1 to 9, wherein the hydraulic motor is either a hollow shaft gearbox/bent axis piston hydraulic motor or a hollow shaft direct drive piston motor.

According to Clause 11, the engine load management system of any of Clauses 1 to 10, wherein the second engine comprises a hydraulic pump that provides hydraulic fluid to the hollow shaft gearbox/bent axis piston hydraulic motor or to the hollow shaft direct drive piston motor through a pressure line.

According to Clause 12, the engine load management system of any of Clauses 1 to 11, wherein the hydraulic pump providing hydraulic fluid to the hollow shaft gearbox/bent axis piston hydraulic motor or to the hollow shaft direct drive piston motor is a closed loop variable displacement hydraulic pump.

According to Clause 13, the engine load management system of any of Clauses 1 to 12, wherein the header and feeder are driven by whichever drive from the first engine or the second engine is turning faster and wherein load is transferred to whichever engine is providing power to that drive.

According to Clause 14, 5he engine load management system of any of Clauses 1 to 13, wherein: the first engine is mounted longitudinally on a first side of the agricultural harvesting combine; and, the second engine is mounted longitudinally on a second side of the agricultural harvesting combine.

According to Clause 15, the engine load management system of any of Clauses 1 to 14, wherein the first engine and the second engine are mounted on a top side of the agricultural harvesting combine.

According to Clause 16, the engine load management system of any of Clauses 1 to 15, wherein the first engine powers harvesting subsystems.

According to Clause 17, the engine load management system of any of Clauses 1 to 16, wherein the harvesting subsystems comprise one or more of a threshing rotor, a residue chopper, a cleaning system, a feeder house, a sickle cutting header and a corn head.

According to Clause 18, the engine load and management system of any of Clauses 1 to 17, wherein the hydraulic pumps of the second engine power vehicle propulsion, power steering, crop cleaning fans, engine cooling fans, grain conveying augers and grain tank unloading system.

Numerous embodiments have been described, hereinabove. It will be apparent to those skilled in the art that the above methods and apparatuses may incorporate changes and modifications without departing from the general scope of this invention. It is intended to include all such modifications and alterations.

What is claimed is:

1. An engine load management system for an agricultural harvesting combine having dual engines comprising:
a first engine mounted on a first area of the agricultural harvesting combine;
a second engine mounted on a second area of the agricultural harvesting combine;
a belt drive which receives power from the first engine;
a gearbox having an input and an output;
an input drive shaft connecting the first engine to the input of the gearbox;
a clutch which receives the input drive shaft and connects it to the input of the gearbox;
a lower feeder drive shaft connected to the output of the gearbox, wherein the gearbox is positioned at a first end of the lower feeder drive shaft;
wherein the belt drive on the first engine powers a header and a feeder; and,
wherein the second engine powers hydraulic pumps.

2. The engine load management system of claim 1, wherein the belt drive is a belt and pully speed variator.

3. The engine load management system of claim 2, wherein the belt and pully speed variator powers a feeder house which returns power back to the feeder.

4. The engine load management system of claim 3, wherein the clutch connecting the input drive shaft to the gearbox is an overrunning clutch.

5. The engine load management system of claim 4, wherein the gearbox is a “T” gearbox.

6. The engine load management system of claim 5, wherein the overrunning clutch drives in one direction and freewheels in an opposite direction upon disengaging the input drive shaft from the “T” gearbox, thereby allowing for different speed differentials.

7. The engine load management system of claim 6, wherein the overrunning clutch allows the “T” gearbox to free-wheel if the lower feeder drive shaft is running faster than an operation speed of the belt and pully speed variator.

8. The engine load management system of claim 1, wherein the lower feeder drive shaft extends to engage a second clutch and a hydraulic motor, wherein the second clutch and the hydraulic motor are positioned at a second end of the lower feeder drive shaft.

9. The engine load management system of claim 8, wherein the second clutch is an overrunning clutch and the hydraulic motor is a hollow shaft hydraulic motor.

10. The engine load management system of claim 9, wherein the hydraulic motor is either a hollow shaft gearbox/bent axis piston hydraulic motor or a hollow shaft direct drive piston motor.

11. The engine load management system of claim 10, wherein the second engine comprises a hydraulic pump that provides hydraulic fluid to the hollow shaft gearbox/bent axis piston hydraulic motor or to the hollow shaft direct drive piston motor through a pressure line.

12. The engine load management system of claim 11, wherein the hydraulic pump providing hydraulic fluid to the hollow shaft gearbox/bent axis piston hydraulic motor or to the hollow shaft direct drive piston motor is a closed loop variable displacement hydraulic pump.

13. The engine load management system of claim 11, wherein the header and feeder are driven by whichever drive from the first engine or the second engine is turning faster and wherein load is transferred to whichever engine is providing power to that drive.

14. The engine load management system of claim 1, wherein:
the first engine is mounted longitudinally on a first side of the agricultural harvesting combine; and,
the second engine is mounted longitudinally on a second side of the agricultural harvesting combine.

15. The engine load management system of claim 14, wherein the first engine and the second engine are mounted on a top side of the agricultural harvesting combine.

16. The engine load management system of claim 15, wherein the first engine powers harvesting subsystems.

17. The engine load management system of claim 16, wherein the harvesting subsystems comprise one or more of a threshing rotor, a residue chopper, a cleaning system, a feeder house, a sickle cutting header and a corn head.

18. The engine load and management system of claim 1, wherein the hydraulic pumps of the second engine power vehicle propulsion, power steering, crop cleaning fans, engine cooling fans, grain conveying augers and grain tank unloading system.
